(19) United States
(12) Patent Application Publication
(10) Pub. No.: US 2015/0379785 A1
(43) Pub. Date: Dec. 31, 2015

(54) WIRELESS MONITOR MAINTENANCE AND CONTROL SYSTEM

(71) Applicants: Owen J. BROWN, JR., (US); Owen L. BROWN, (US); Ryan BROWN, (US)

(72) Inventors: Owen J. Brown,, JR., Pittsfield, IL (US); Owen L. BROWN, Pittsfield, IL (US); Ryan BROWN, Pittsfield, IL (US)

(21) Appl. No.: 14/766,028

(22) PCT Filed: Feb. 7, 2014
(86) PCT No.: PCT/US14/15183

§ 371 Date: Aug. 5, 2015

Related U.S. Application Data
(60) Provisional application No. 61/761,874, filed on Feb. 7, 2013.

(51) Int. Cl. G07C 5/00; A01F 15/08; A01C 15/00; A01D 34/00; G07C 5/08; A01C 14/00

(52) U.S. Cl. CPC G07C 5/006; G07C 5/08; A01C 14/00; A01C 15/00; A01D 34/008; A01F 15/08

(57) ABSTRACT

A system of mobile computer equipment, sensors and software methods for generating alerts, recommendations, control signals and report outputs for primarily towed machines, the method including receiving wirelessly data sets from a plurality of sensors, comparing them to a database of optimal values for each data set and generating an audible or visible output to a wireless hand-held graphical user interface including any combination of machine stroke count per unit produced to generate yield maps or recommendations to change linear travel rate of such machine, subcomponent performance rating, status or condition, recommendation and details to perform specific repair and maintenance procedures, order specific spares, production inventory field locations and other outputs, to optimize the productivity and uptime of such mobile machines.

### CROSS REFERENCE TO RELATED APPLICATIONS

This application claims the benefit of provisional patent application Ser. No. 61/761,874, filed Feb. 7, 2013.

### STATEMENT REGARDING FEDERALLY FUNDED RESEARCH Not applicable

### TECHNICAL FIELD OF INVENTION

The present invention relates to a system comprising a software method, hardware and wireless communication networks for controlling, monitoring, troubleshooting and optimizing typically mobile equipment, particularly types of equipment towed behind a primary power vehicle such as a tractor, including those generally used for processing and handling fibrous materials, such as for example hay, straw, grass and alfalfa cut, collected and formed into bales and bundles of bales.

### BACKGROUND ART OF THE INVENTION

Modern farming practice typically involves a multitude of equipment for preparing fields for planting, planting seed, cutting or mowing of the crop, and pickup and transfer of the harvest to storage and eventual sale. In the case of substantially fibrous crops, such as hay, silage or straw, farmers typically utilize a tractor or other power mechanism to pull a cutter to cut the crop and lay it in the field, and subsequently gather the crop in a narrow band or windrow. At some time after cutting, a tractor is typically used in combination with a baling mechanism, to compress and package the crop into square or round bales. In the process of baling, modern farmers often also utilize a labor saving mechanism attached to the baler or tractor to pick up the bales and stack and package the bales into larger assemblies or bundles to reduce the labor cost involved in transporting and distributing the small square bales.

### PRIOR ART AND TECHNICAL PROBLEMS TO BE SOLVED

While modern bale handling, accumulator and bundling equipment, hereinafter referred to as a bundler, such as the Bale-Bandit (RTM GFC, INC.) may have onboard computing means to sequence each step, these devices have been typically autonomous, with little or no feedback or signal means to the farmer in the cab of the tractor. Also, the optimal operation of bundlers and other implements depends on setting certain parameters which vary depending on the equipment used and conditions during operation. In the prior art it has been difficult for an operator of an implement to know how to optimize his implement's and as a result his farm's productivity. Particularly, with the advent of increasing complexity in equipment used, more complex substantially automated equipment has placed an increasing burden on operators of towed implements to keep their operation, yield and productivity at competitive levels. While there have been minor alarms in prior art, such as general indications of oil pressure or coolant temperature, or a vague indication to check the engine, there has been little means in the past available to the operator to optimize the performance or provide troubleshooting of specific details and subcomponents on complex equipment, particularly while out in rural areas far from any technical support technician. Due to the critical nature of crop harvesting and packaging, such as baling and bundling during suitable weather, an operator cannot afford substantial downtime to take the implement back to a service center or wait for a trained repair technician to arrive, particularly since most farming operations are far from major cities. In addition, while there are yield monitors available for grain crops such as corn and soybeans, there has been no means to provide yield per acre information to the typical hay farmer from either the baler or the bundling equipment. Furthermore, there is a wide range of sizes, makes and models of tractors on the market, each with varying flowrates and capacities of hydraulic fluid required to power and operate towed devices such as baler and bundler actuators. In addition, it is advantageous to farmers of large farm operations to be able to measure and track both the productivity of the work crews and the equipment employed, troubleshoot operating equipment in the fields at the point of use and also remotely, and also to keep track of the location and weight of the crop, bales or bundles processed in the field.

While there are modern advanced tractors available with input/output screens to provide information about the tractor, the screens are hardwired to the control panel. If any aspect of the tractor, or any implement towed by the tractor, begins to drift out of the optimal operating range, jams or otherwise malfunctions, there is not a simple means to observe or troubleshoot the mechanism operation outside of the tractor cabin, nor any means to predict pending malfunctions or maintenance needs and receive a detailed repair or maintenance procedure.

In U. S. Patent Application No. 20140012732 by Lindores, dated Jan. 9, 2014, a method is disclosed for generating a grain crop recommendation, a plurality of data sets are received by a computer system from a plurality of disparate data sources, such as crop color, moisture content, weather and other factors affecting a crop. A benchmark is created by the computer system for each of the data sets which describes how the factor affects the market value of the crop. A model is generated by the computer system which describes the crop based upon each of said benchmarks from the plurality of data sets. A report is then generated by the computer system comprising at least one recommendation to adjust fertilizer or other chemical application to increase the market value of the crop. The primary input is based on differences in optical reflectivity of plants and dirt at different wavelengths, and is thus not designed to work on no-till crops such as hay and alfalfa in which there is a fairly constant layer of vegetation. The system requires exotic and expensive sensors and processing equipment, and the output provides no data on inventory location nor on the status or optimization of equipment speed or status. The system does not monitor or control any equipment.

An article published by University of Nebraska, available on the internet at http://cropwatch.unl.edu/web/ssm/mapping, describes a method for yield mapping of grain crops. The method described requires a multitude of expensive and fragile sensors, including a grain flow sensor, grain moisture analyzer and others, to determine the weight of the crop. This method is not cost effective in measuring the yields of high tonnage, high collection-rate crops such as hay nor is it suitable for use on high vibration environments such as those encountered on baling and bundling equipment. Furthermore, the method does not provide any signal or output to enable the equipment operator to adjust the speed of the crop gathering, baling or bundling means to optimize the productivity thereof

In U.S. Patent Application Publication No. 20100065155 dated Mar. 18, 2010 a hard-wired system is described for a “forest machine” defined as a self-propelled machine for grasping and sawing trees. The system and method measures and computes the averages and variations in cutting time and in fuel consumption. The system as disclosed provides no corrective action recommendations. Therefore its specific functions and performance information as well as database components are different than and do not correlate to equipment generally used for processing and handling fibrous materials, such as for example hay bales. The display is fixed and hard wired in the vehicle driver cab, and the system provides no root cause analysis, no troubleshooting or repair recommendation nor yield per acre computations nor information to improve the productivity of the machine.

In U.S. Patent Application Publication No. 20010042362 dated Nov. 22, 2001, Scarlett et al describes a system for controlling the travel speed of a tractor/baler combination used for bales generally greater than 300 lbs, using a collection of torque sensors, spring-loaded doors, proximity switches, transducers and other sensors to arrive at an approximation of the flow rate of cut hay into the baler, comparing this rate to a preset optimal rate and transmitting a command to an electromechanical transducer on the tractor to adjust the tractor engine fuel flow or transmission speed thereof to slow down or speed up the tractor. The use of one or a multitude of costly delicate sensors and springs in the flowpath of cut, dusty or wet, random-orientation hay at high rates and in a dirty high-vibration environment typical in a baler, can lead to inaccurate readings and damage and short service life for such sensor and spring arrangements. Also, by basing the changing of engine rpm or gear ration on variations in cut grass flow occurring every few seconds, the fuel efficiency and/or transmission life of the tractor can be severely reduced. The use of a strain gage on a spring loaded door in the load box does not account for intermittent bridging or jamming of the hay in the box leading to inconsistent load against the spring door. The system provides no means to troubleshoot the baler mechanism, nor to observe or index the baler operational steps while outside the tractor cab, to repair or address any jam, sensor failure or other anomaly. Also, the system is only applicable to balers of relatively large size, not useable for small square balers which typically contain no such inlet load box chamber.

In Patent Application Publication No. 20130116896 dated May 9, 2013, Blank describes a system and method for combining and formatting sensor signals to attempt controlling the travel speed of a tractor pulling a baler based on width image approximation of a windrow, comprising a camera facing the crop in front of the tractor, and a multitude of a wide array of torque and other sensors to approximate the flow rate of the cut crop material into the baler, converting the various sensor signals into a common format via formatting and conversion data means, and generating a signal means via hard wire connection to a controller mounted in the tractor cab to adjust the speed of the tractor. This method and system does not describe how the camera or sensors adjust for the variance in fiber density, moisture content or orientation of the cut crop windrow, all of which will vary the flow rate of crop into the baler. This method and system suffers the same shortcomings of cost, fragility, non-mobility, non-self-troubleshooting and others of the system disclosed in Publication 20010042362 in addition to lack of reduction to practice or disclosure of means for adjusting for variances in windrow density and moisture.

U.S. Patent Application Publication No. 20120136507 describes a system and method for remotely stopping the primary power drive unit and motion of haulers, excavators and similar automated earthmovers at a construction worksite when in the proximity of a person, such system including a portable interface unit to generate a stop command to the processor resident on the autonomous excavator drive unit. The portable display unit output of this system is limited to the stopping of the unit, status of display unit power source and cancellation of the stop signal. This system provides no useful data to the human operator interface other than the status of the handheld unit and that the stop signal has been transmitted or cancelled. This system is not suited to controlling any other function of the primary drive unit nor the function of any towed implement attached to the power drive unit, nor to operate the primary power unit in any function, nor provide any maintenance, or performance monitoring, other than to stop the primary power unit.

None of the software methods, systems or devices comprising prior art cited above provide the synergistic combination of reliability monitoring, operations optimization, inventory management and repair recommendations integrated into a mobile, interactive and relatively lightweight, durable, robust low cost system, nor the synergistic results of providing output of such monitoring, maintenance and control means to a human or electromechanical operator whether the operator is inside or outside of the cab of the primary drive unit such as a tractor.

### SUMMARY OF THE INVENTION

It is an object of the present invention to overcome the aforementioned technical problem of optimizing the uptime and productivity of equipment such as towed implements, and to overcome the disadvantages of the prior art and the address the previously unmet needs listed below by providing a method and apparatus for synergistically monitoring, troubleshooting, reporting on and controlling a system of one or more implements towed or pushed by a motorized vehicle, by sensing particular inputs from the implements, processing inputs and transmitting them wirelessly to a portable human-machine interface, and utilizing the outputs to thereby improve the system productivity and production inventory management. What is needed is a system that can wirelessly control, troubleshoot and/or monitor implements conveyed by vehicles, such as a tractor pulling crop cutting, processing, baling and/or bundling equipment, with a portable human-machine interface easily reconfigurable to one or more types or sizes of tractors or powered vehicle means. What is needed is a system that can graphically generate not only crop yield maps, but also locations and amounts of harvested crop inventory positioned in the field, can measure and report farm equipment productivity, consumables status and machine status rapidly in essentially real-time. What is needed is a system that can adjust optimal performance criteria upper and lower control limits and ranges based on tractor hydraulic flow rate and operating conditions, with a wireless real-time troubleshooting system able to survey users and provide decision-tree root cause analysis resulting not only in immediate reliability, maintenance and repair alerts and reports, but also quickly provide detailed subcomponent maintenance and repair recommendations and procedures to the operators and remote owners of the equipment, resulting in a synergistic increase in implement and operator productivity in the field of use. The subject invention answers all these needs in the prior art, resulting in a lightweight, powerful command and control center in the hands of the operator, available inside or outside the cab of the towing vehicle, able to provide a previously unachieved level of mobile implement monitoring, reporting, troubleshooting and control means, resulting in an incredible increase in operational productivity, inventory management, yield improvement and implement device reliability and uptime.

### BRIEF DESCRIPTION OF THE DRAWINGS

FIGS. 1-4 are views of the main home screen output view of the subject invention, each showing different functions or graphical user interface means of the subject invention.

FIG. 5 is a view of the Troubleshooting Screen and various graphical user interfaces (GUI).

FIG. 6 is a view of the Controls Screen and various GUI.

FIG. 7 is a view of the History Screen and various GUI.

FIGS. 8-9 are views of the Performance Screen output view of the subject invention, each showing different functions or GUI items.

FIG. 10 is a view of the Maintenance Screen and various GUI.

FIG. 11 is a view of the Info Screen and various GUI.

FIG. 12 is another view of the Troubleshooting Screen and various GUI.

FIG. 13 is a view of the Settings Screen and various GUI.

FIG. 14 is a graphic perspective view indicating the general orientation of the Monitor, Baler Stroke Counter and Bundler wireless data transmission means.

FIG. 15 is a general graphical representation of a method of typical inputs received from the equipment processed into the typical outputs, and the communications flow path according to the invention;

FIGS. 16 and 17 are a flow chart summarizing the steps of a method according to the invention.

### DETAILED DESCRIPTION OF THE EMBODIMENTS

What is disclosed is a new software application, method and apparatus system for controlling, monitoring, troubleshooting and optimizing types of equipment generally used for processing and handling fibrous materials, such as for example cutters, balers and bale handlers of crops including hay and other fibrous vegetation. The equipment benefitting from this application include but are not limited to all sizes and models of typical hay, straw and cotton balers generally available commercially from companies including John Deere, New Holland and other commercial sources, and the patented Bale Band-It bale stacking and bundling machine, produced and sold commercially by GFC, Inc., as well as other similar crop agglomeration and bundling machines referred collectively to as bundlers.

Herein the invention software method application is referred to collectively as the iBand-It app, and the combination of the iBand-It app and the interactive links and any combination of equipment mechanisms and sensors described herein collectively referred to as the iBand-It System.

This new, novel and useful iBand-It System uses a portable input-output terminal such as the iPad (rtm Apple) as the touch monitor human-machine interface means. The iBand-It System also can be used on other wireless means including on an Android® electronic device platform or on other Apple or similar flat touchscreen or other portable devices. The iBand-it system uses the iPad platform or other similar wireless device to provide an easy to view, easy to use, powerfully advanced information center.

In one embodiment, for the baler optimization output signal to the human operator, the invention subsystem utilizes an electromechanical switch or sensor means connected to the baler compression ram stroke actuator piston or arm structure, in a departure from prior art, not in the flowpath of the crop material flowing through the baler. This subcomponent functions as what is referred to as the baler stroke counter.

The system communicates with both the baler stroke counter mechanism and the Bale Band-It machine microprocessor either via direct data wire or wirelessly, such as via a Bluetooth® or other wireless data transmitter/receiver means commercially available.

The iBand-It System is a key component of an integrated, substantially automated direct support and predictive/preventive/repair/productivity optimization system for implements typically moved by tractors or other vehicles. It takes critical operational information from the implement and makes it easy for the system operator to view and utilize to optimize system performance, productivity and reliability. It alerts the human operator of the equipment to upcoming problems based off actual performance times and parameters of operational steps by the equipment. The pictorial troubleshooting guide has technical expertise built in, stepping the operator through each troubleshooting step and providing the recommended detailed repair and maintenance steps. The video conferencing capabilities allow expert technicians to quickly connect to the customer's system, in the event direct factory support is desired. In order to support any product well, the correct maintenance, repair or corrective action information has to be transferred to the operator or product to address the problem in an expedited, preferably near-real-time manner. The subject invention connects the machine operator with a wealth of streamlined information at their fingertips, when used singularly or in combination results in an unexpectedly synergistic improvement in equipment productivity, reliability and maintainability combined with beneficial inventory, crop and field management.

Referring to the Figures and exhibits, disclosed are the useful, nonobvious and novel methods, devices and features of the iBand-It app to integrate and perform the subject invention comprising the iBand-It System, including the output screens and graphical user interfaces, outputs, reports and indicators:

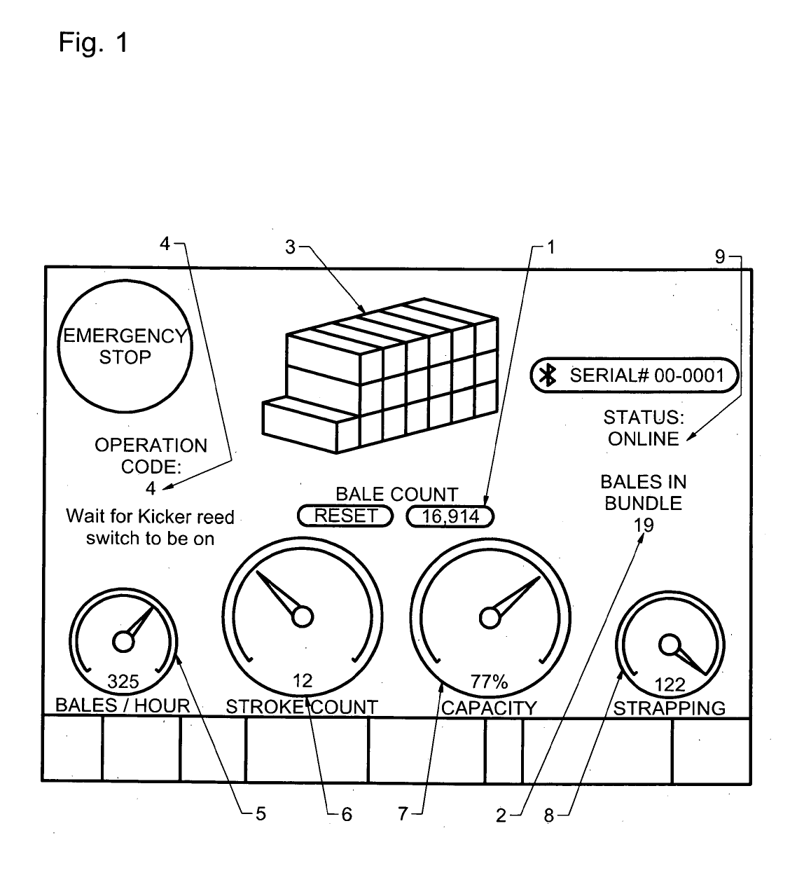

FIG. 1 shows the Main Home Screen output view of the subject invention, comprising one or more of the features, GUI's, outputs and functions described herein including one or more of the following: i) Total Bale Count 1 enables operator to monitor productivity for a given time period, including bales formed per hour, per shift or per day; ii) Bales in Bundle 2 specific to bundlers such as the Bale Band-It machine, tells the operator total bales that have been placed in the standard 21-bale or specified-count bundle; iii) Visual Representation of Bales in Bundle 3 graphically shows the operator how many bales have been placed in the current bundle being constructed in the Band-It, to determine how many bales remain to be inserted in the event the machine must be stopped momentarily to clear an damaged, busted or otherwise defective bale such as arising from containment twine failure; iv) Operation Code Number 4 output from the iBand-It provides the operator what operation step number and description the machine is currently in the normal sequence of operations, should the machine need to be restarted or repaired in mid-sequence; v) Bales/Hour Gauge 5 gives the operator tangible crop baling productivity numbers, taking inputs transmitted from the bundler, calculating and displaying rate of bales bundled per hour; vi) Baler Stroke Count Gauge 6 displays provides graphical and/or auditory information telling the operator how many mechanical ram strokes were required to create the current or most current bale in the baler. With this value, in combination with the tractor linear speed, the iBand-It can communicate to the operator, either graphically, audibly or both, to speed up or slow down the tractor mechanism, to optimize the performance of i) the baler or bundler alone and/or ii) both the baler and the Bale Band-It or bundler machines in combination. The optimal stroke count for most commercial balers tested with this system is between ten and fifteen strokes per bale. This optimal stroke range, actual stroke count and bale count output value is preferably stored automatically into the system database, combined with the positional GPS data input provided via satellite to the iPad during each stroke or each bale produced, to subsequently calculate and report how many pounds of hay or product was yielded per acre or other unit measurement of land, for subsequent adjustment in fertilizer application and watering if adjustment means are available. This yield per unit area and GPS data may be stored and directly subsequently downloaded into programmable water or fertilizer means to optimize the application of such crop inputs. Unlike prior art, by averaging and reporting the calculated rate of stroke count per bale over the entire bale, and graphically indicating the count in relation to an optimal range with upper and lower limits, the typical small variations in windrow density are buffered out by averaging and trending, resulting in a more gradual adjustment of tractor speed by the operator, increasing fuel efficiency, equipment life and safety; vii) The Bale Band-It Capacity Gauge 7 tells the operator if the linear speed of the tractor can or should be increased, or the hydraulic flow (in volume per unit time) increased, if the speed or flow is below design capacity specifications. It can also warn if the linear speed should be decreased if speed or flow is above capacity specifications. This preferred embodiment can also alert the operator that part of the system may need maintenance or repair; viii) The Strapping Count Gauge 8 graphically and/or numerically output on the screen from the signal means transmitted from the bundler strap roller liner transfer sensor, tells the operator how many additional bundles may be strapped before the system runs out of strapping, thereby preventing a bale to be wasted or busted within the bundler machine, leading to unscheduled downtime and resultant loss of productivity present in prior art bundlers. The Bluetooth connection status 9 tells operator if the wireless links between the machines and the iBand-It system are active (online) or disconnected (offline).

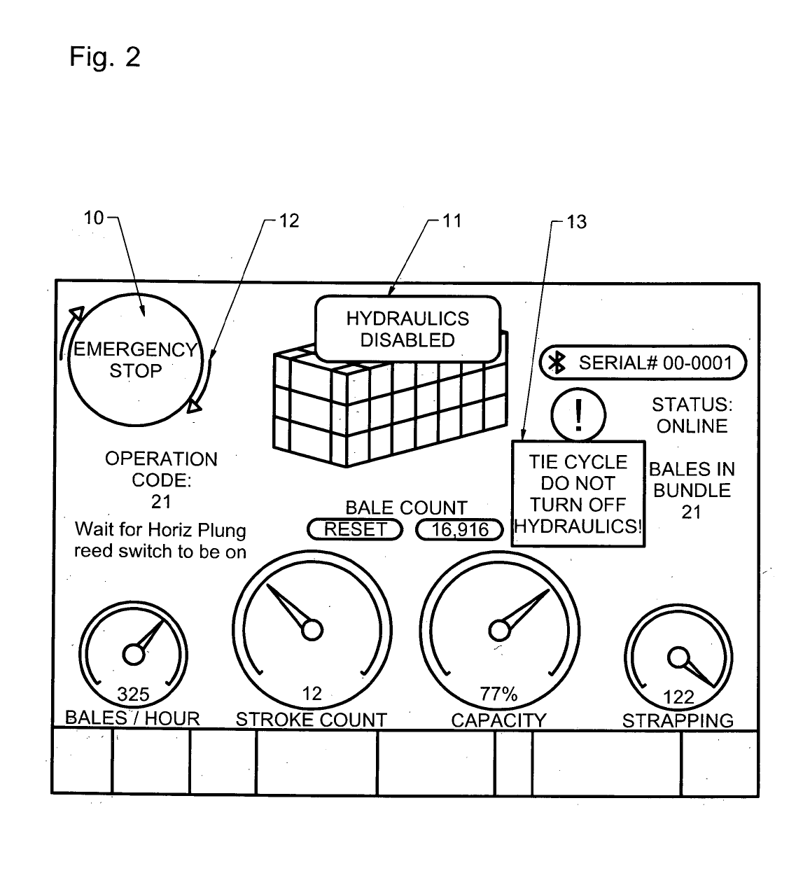

FIG. 2 shows additional outputs and graphical user interfaces further included on the Main Home Screen output view of the subject invention. The Emergency Stop 10 allows the operator to quickly shut down the Bale Band-It or bundler system hydraulic pressure, stopping the system from continued motion by simply touching this location on the screen. This stop condition is also alerted to the operator by the on-screen window stating hydraulics disabled 11. This is particularly useful if a bale is busted or other obstructions or mechanical issues have occurred. Preferably, as an additional safety feature the operator must complete a two finger rotational twist 12 on the Stop 10 interface in order to send a wireless signal to the bundler logic controller to open hydraulic valves to re-enable hydraulic flow and pressure. This said two finger twist 12 requires two fingers to both be on the Emergency Stop 10 button and to rotate a minimum specified angle to prevent inadvertent activation from merely touching the button. The Tie Cycle Alert 13 informs operator of any critical portion of cycle when hydraulics must not preferably be manually turned off

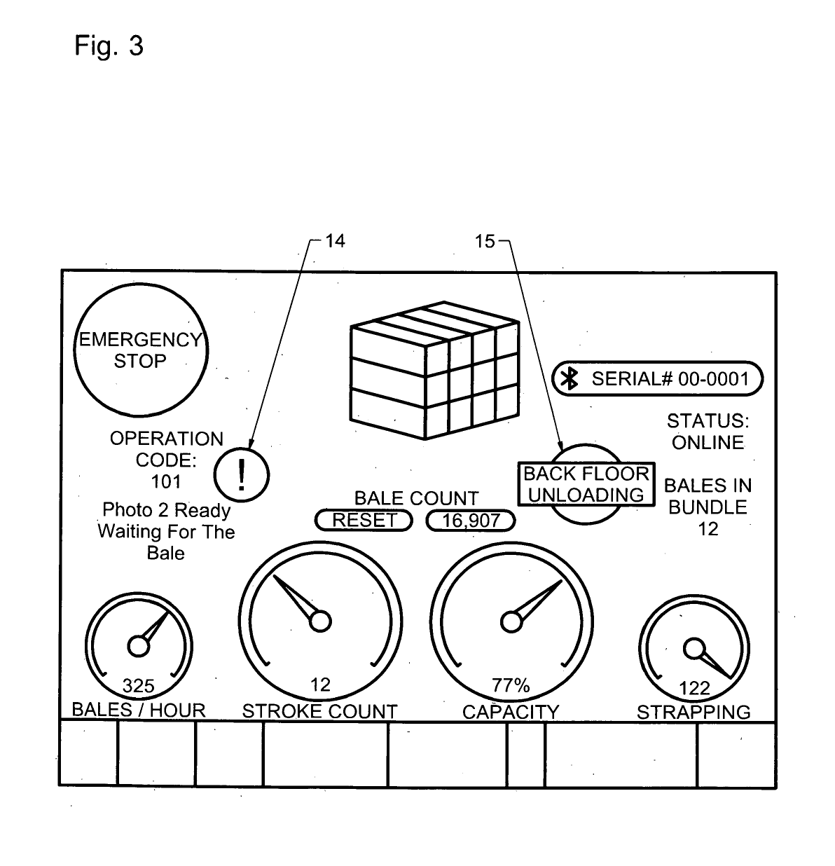

FIG. 3 shows additional outputs and GUI's and functions, one or more of which is part of the the Home Screen with various applicable outputs. The Operation Status is dynamically updating operator with important information, including operational codes and alerts. The Busted bale alert 14 notifies the operator of a damaged or busted bale in the conveyor train. When the first photoelectric sensor in the bale flowpath is tripped on the bundler, the microprocessor is programmed to count a set time and if the subsequent photoelectric sensor is not tripped in the specified time it alerts operator to verify if there is a busted bale. In the event that is verified, then the operator can switch the interface screen to the controls page and use the iBand-It control interfaces to manipulate the busted bale out. The Back Floor Unloading 15 output signals operator that a bundle of bales is being ejected off the back of the Bale-Band-It system.

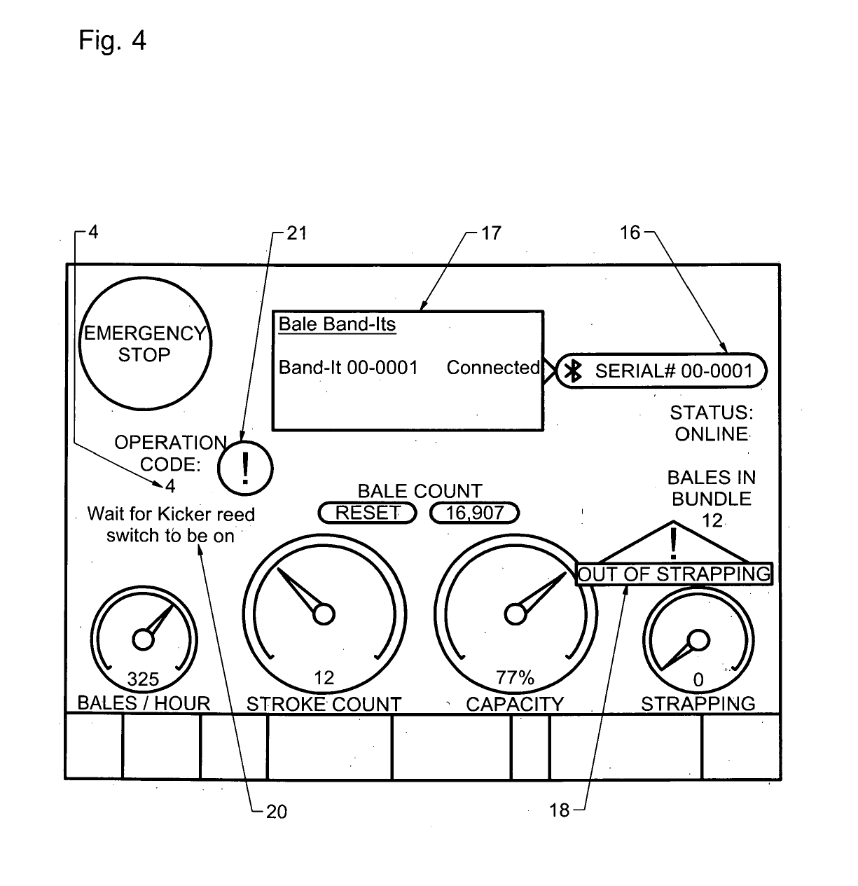

FIG. 4 shows the Home Screen with additional useful outputs and graphical user interfaces any of which may further comprise the Home Screen. The Serial Number Bar 16 can be clicked to open a graphical popup window 17 which displays available Bale Band-It iBand-it systems activated within the wireless transmission means area. Operator touches one choice to connect or disconnect to a specific Bale Band-It system. The Out of Strapping Alert 18 utilizes a processed signal from a photosensor on the bundler to inform the operator that the Bale Band-It bundler is out of strapping. The bundler operation is then either manually or preferably automatically stopped.

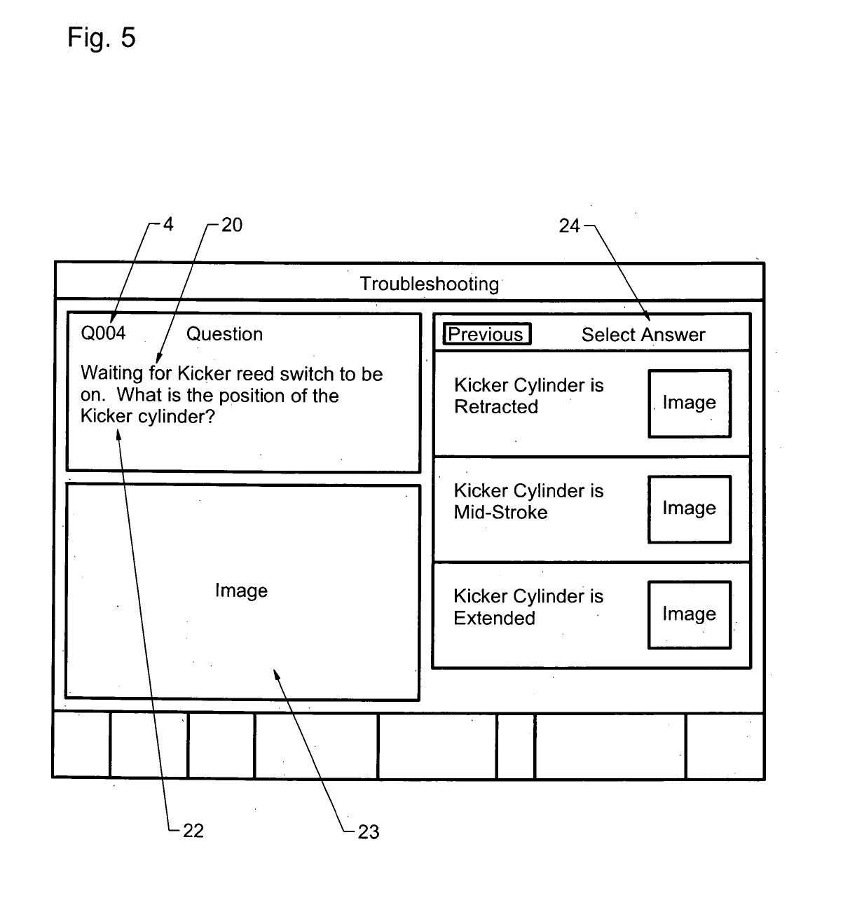

The Home Screen output includes all operation codes which are stored in the system database for each of a large multitude of system anomalies, malfunctions, system faults and other conditions that could hinder operation or productivity of i) the Bale Band-It, ii)the baler or iii) both machines. By way of example, Operation Code Number 4 on FIG. 4 gives corresponding Operation Description 20 which specifies what process step the Bale Band-It is waiting to have completed. By the operator pressing Alert Button 21 the system takes the operator directly into the Pictorial Troubleshooting Guide for that Operation Code Number 4—see FIG. 5. In the disclosed example, Operation Code Number 4 and Operation Description 20 are the same as on FIG. 4. Operator is immediately prompted with Question 22. Preferably an associated picture or drawing 23 is given to aid operator in answering the question. The operator is then visually prompted 24 to select what state the Bale Band-It currently is in. The operator in cooperation with the system Questions 22 continues to drill down in the query and decision-tree root cause analysis provided in the system until the the system gives the correct trouble-shooting repair or maintenance solution to the anomaly or malfunction.

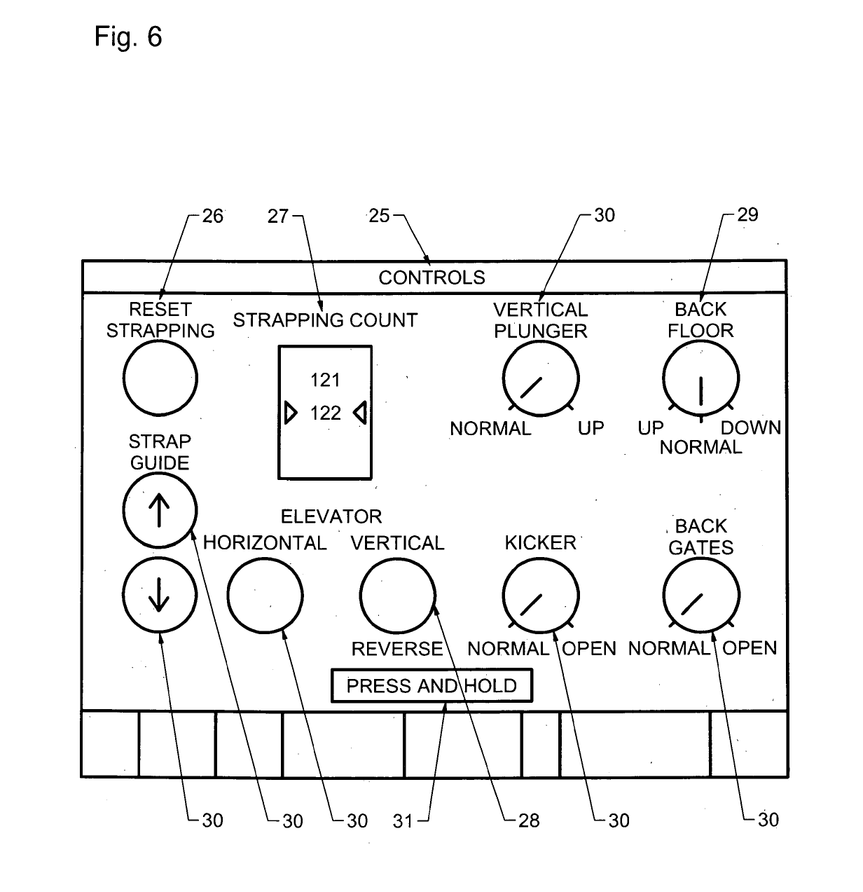

FIG. 6 shows the Controls Screen, which includes and provides one or more of a number of outputs, functions and graphical user interfaces set forth herein. Real-time, on the go controls for all the Maj or Subsystems 25 allows operator to remain in control from the tractor seat and manually operate the bundler system, particularly to manipulate and eject a busted bale from the system. Alternatively, by the human-machine interface being battery-powered and portable, the operator may leave the tractor seat and observe the bundler and baler machine operation from many angles around the perimeter of said machines, when appropriate. The Reset strapping Count 26, resets the count stored in the system database, based on a predetermined value when the reel of strapping is replaced. The Dial in Strapping Count 27 enables operator to fully utilize and account for strapping remaining on the reel. The Reverse Vertical Elevator Chain Button 28 transmits wireless signal from the iPad to the bundler data receiver which is processed and transmitted to the motors or other bundler mechanical means to reverse the direction of the bale transfer chain, to eject any busted bale. The Raise and lower back floor 29 function applies when ready to transport the bundler. To transport one would only raise the floor. If machine has back floor down, then one raises the back floor for transport, and then when in new location, places in normal and floor will drop. A situation where the operator may want to lower the floor would be if one was packaging bundles in a stationary setting (i.e. no ground speed and therefore bundles have to be removed with a loader instead of unloading automatically on the go) and did not remove bundle at proper time, then lowering the floor would aid in unloading the bundle.

One or more implement functional controls 30 resident on the subject invention interface Control Screen are helpful in an implement malfunction, for example a bale breakage and jamb situation. It is possible for the kicker cylinder or vertical plunger cylinder to be stalled out due to a broken bale preventing completion of the function. It would then be useful to move the kicker into the “open” position or the vertical plunger into the “up” position. These “various functional controls 30 allow the operator to easily move the machine into those positions so that the jammed bale can be removed and the machine can continue functioning. The graphical user interface controls are much easier and safer than manually manipulating the directional valves on the implement machine. As an additional safety feature in the preferred embodiment, the operator must place one finger on the Bale Band-It placard at the lower section of the screen 31, while simultaneously touching the specific function button to activate that specific function on the Bale Band-It machine. The operator may hold the function button down to move the machine or may sequentially tap the button to actuate the system in small increments.

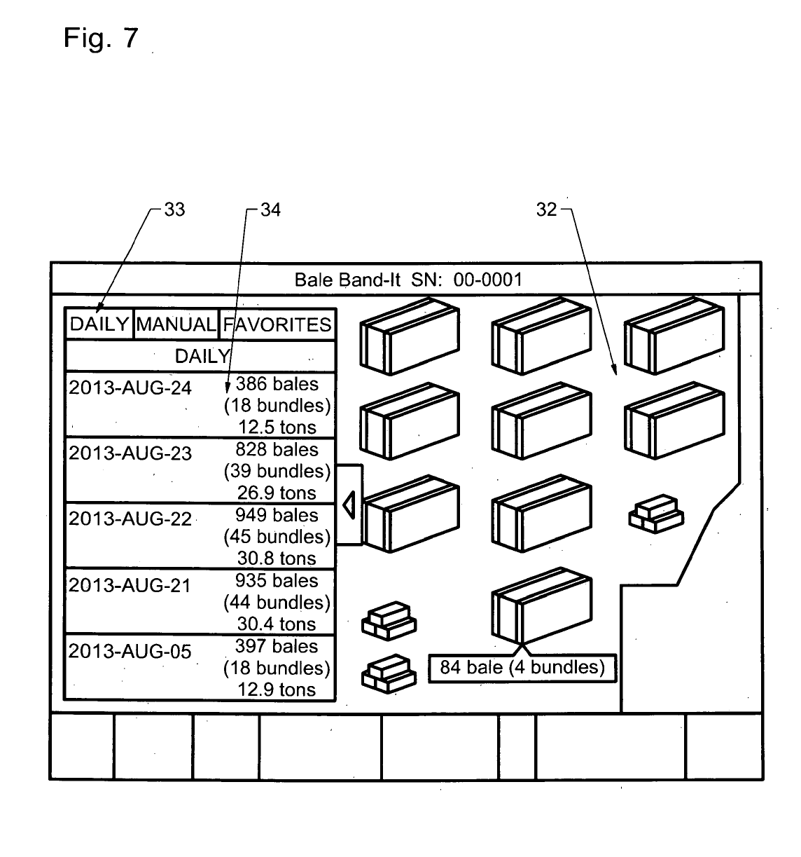

FIG. 7 shows the History Screen which includes a plurality of GUI's and output reports and provides the operator the ability to log history from multiple Bale Band-It bundler or baler machines. History of various inputs received from each machine or sample database can all be viewed individually or together. Utilizing available satellite imagery, such as for example that from Google Maps (TM Google), the system utilizes GPS coordinates transmitted to the iPad during crop harvesting and/or baling or bundling operation to produce a graphical map 32 of production of the fields processed, showing the physical locations of each bale or bundle of crop produced. The iBand-it system i) automatically creates daily logs 33 of baling operations and maps location of each bundle of bales, ii) creates custom logs to keep detailed field by field production records and iii) calculates, stores and displays bale and bundle count for each field and each day 34 and iv) enables operator to visually identify what quantity of product is baled, bundled or positioned in each field. This data is then useful for inventory management and pickup/distribution planning when transferring harvested crops to secondary storage or to customers.

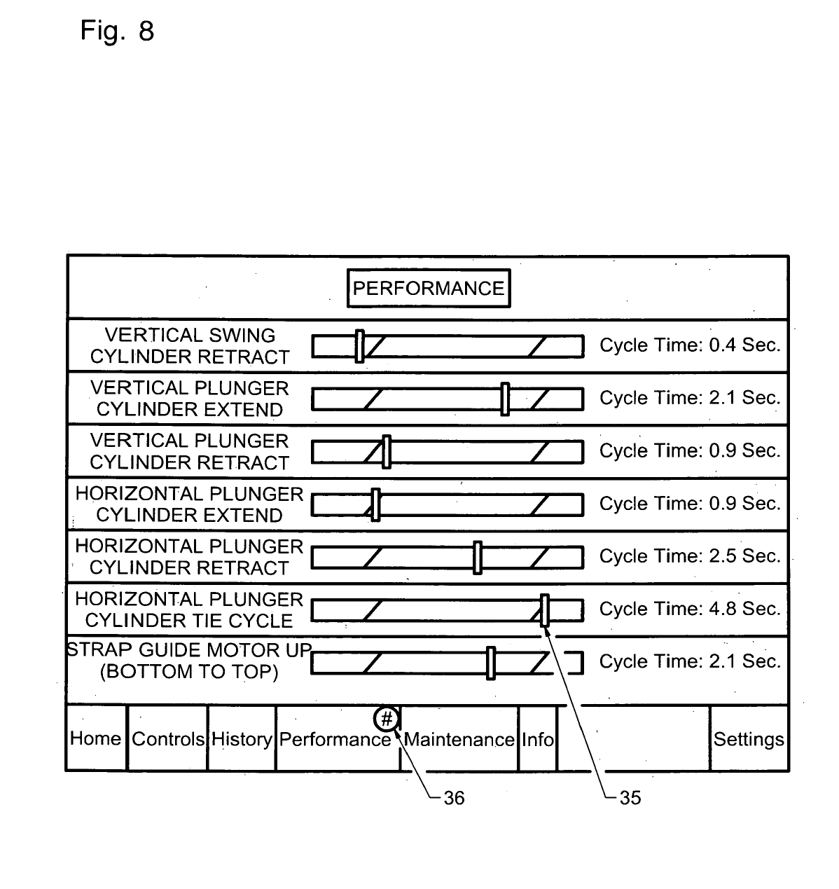

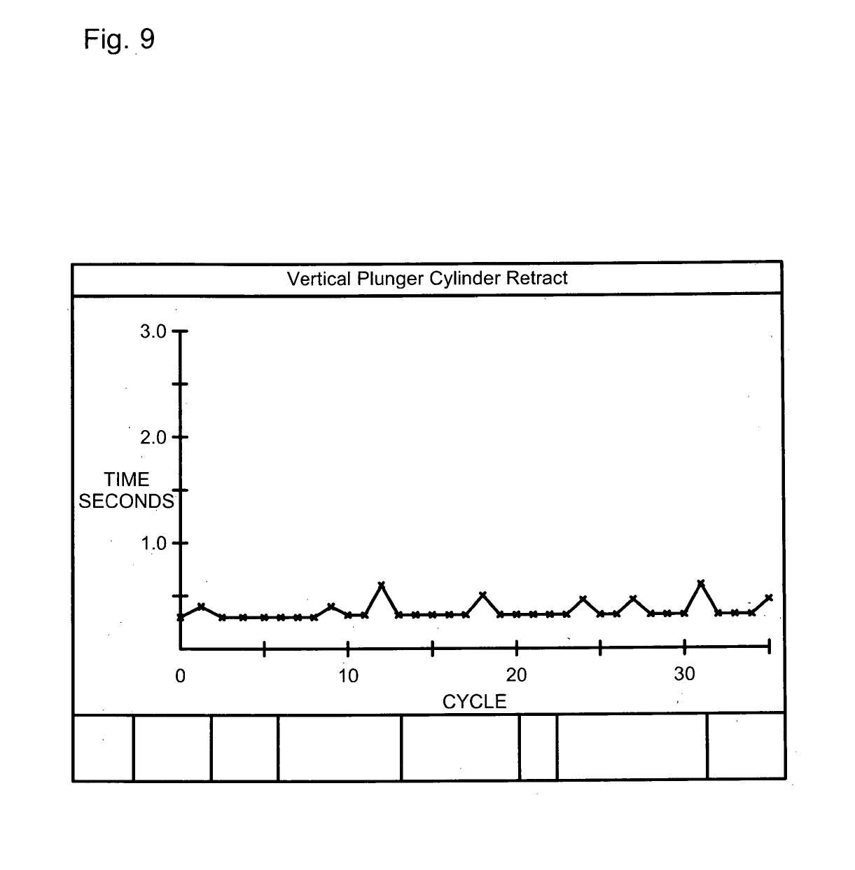

FIG. 8 shows the Performance Screen format of the present invention, which includes one or more of a plurality of functions, outputs and GUI's. Multiple sensors and timers on one or more of the implements or equipment in use provide performance cycle times and other operating data to the wireless data bus, sending the signals to the i-Band-it processor which converts the signals into a graphical user interface (GUI). The GUI displays the values in comparison to a preset or adjustable database of optimal or recommended values for the specific machines being used. In one embodiement, this optimal range for each parameter is shown graphically as a section on the right end on a horizontal line, colored for example red, with the parameter performance values just below the optimal range represented as a zone on the line in a different color, such as for example green, and the parameter performance values further below optimal, indicating a potential repair or maintenance candidate system, represented graphically on the far left of the scale, in an section colored for example red. This output screen monitors and reports the Bale Band-It's or other monitored implement's actual performance for each specific system, preferably both numerically and graphically. With a quick glance while the equipment is in operation, the towing vehicle operator can see or hear, if audible means activated, exactly how well the monitored implement is performing on one or more of a plurality of subsystems. Unlike prior art that merely indicates a subsystem failure, this system provides real-time statistical quality and process control trend analysis prior to such failure. As the graphical indicator 35 approaches the lowest performance zone, this enables the operator to quickly spot subsystems that are drifting or approaching out-of-design specification operation, to provide a detailed indicator of pending malfunction or subsystem failure. Operator is first notified via badge (36) on the Performance tab. The outputs visible on this screen enable operators to quickly view average cycle times per operation, and at a glance verify that the Band-It is operating in the yellow and green “safe zones” that represent cycle times within design specifications. By the operator tapping on any specific subsystem graphic scale, the screen reverts to a linear graph (see FIG. 9) of that system's cycle time per bale processed, to enable operator to drill down to see in-depth charting of each operation and identify which cycle or cycles led to an out of specification average cycle time.

Performance Charting on this Performance Screen enables the operator see the range of cycle times for each specific operation. By graphically showing the highs, the lows, and the history, as well as optionally the upper and lower design specification limits on the graph, this enables the operator to identify trends that can be used to determine if a particular subsystem seal, bearing or other component is approaching the end of its useful life, allow that component to be removed via scheduled maintenance in the shop or in the field, before the component fails in the middle of an operation or in a remote location far from the supply of tools, mechanics or spare parts, before it substantially halts production at an inopportune time. This is particularly useful for mission-critical applications as well, where unscheduled downtime can be extremely expensive or in some cases such as transportation or mobile medical equipment, catastrophic.

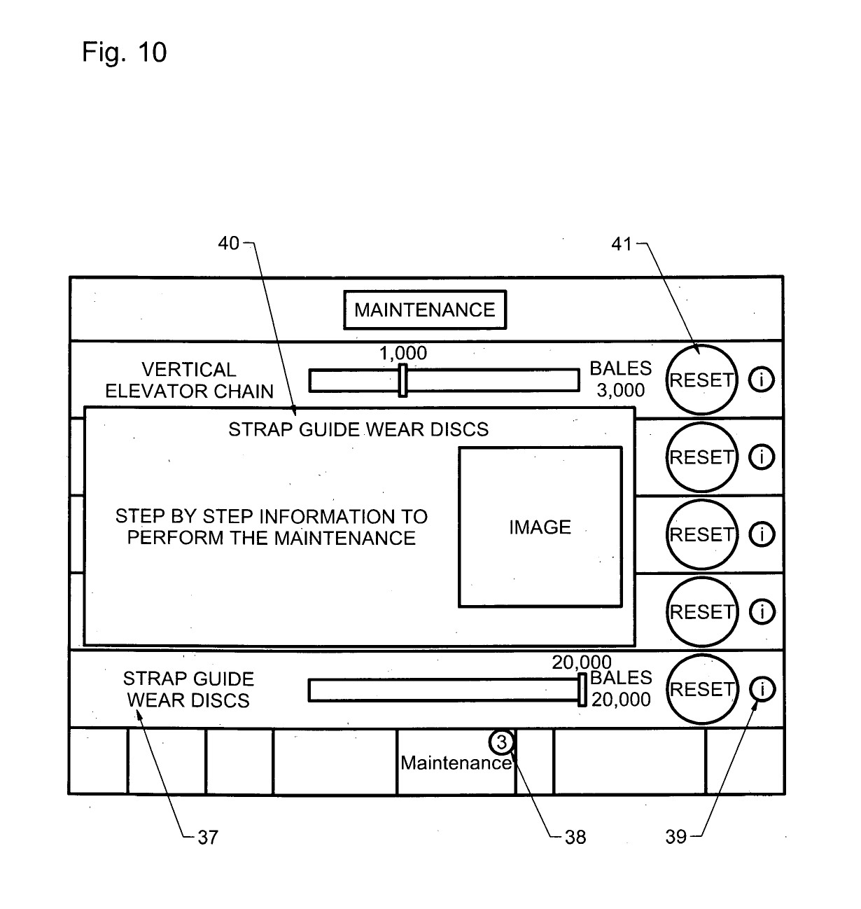

FIG. 10 shows the Maintenance Screen layout of the subject invention, which comprises one or more maintenance outputs, GUI's and functions. Maintenance items listed 37 are the various subsystem components that are to be lubricated or adjusted based on the recommended design specification cycles, and are automatically based off the total crop production output or total cycles of certain movements of the implement since the prior maintenance, for example the bale count of the specific Bale Band-It bundler, or otherwise off a preset or programmable database of machine maintenance requirements or recommendations per applicable subsystem number of cycles. The preferred embodiment automatically adjusts maintenance cycle times based on age and use of the machines monitored. From break in periods (some subcomponents cycle times are shorter on new machines, then increase after first adjustments) to long term maintenance, the iBand-It System keeps the operator updated to what needs lubrication, adjustment, or visual inspection. Badge 38 alerts the operator of maintenance items or tasks that need to be completed. Every maintenance item is preferably listed.

In a novel improvement over prior art, by preferably touching the information button 39 on a given maintenance item, a detailed photograph 40 of the subsystem and step by step information pre-stored on the system database is displayed providing details on tools and methods to do to perform the maintenance. In addition, by checking on other subsystem maintenance items not yet alarming, the operator can quickly view how close a specific subsystem is in remaining cycles to needing recommended maintenance.

Once a maintenance item has been completed, the operator simply presses the reset section, 41 setting the counts-to next-scheduled maintenance indicator to zero and the graphic indicator scale back to the green zone. The number of cycles in the database for the next scheduled maintenance for each subsystem is automatically adjusted once the break in period has been completed.

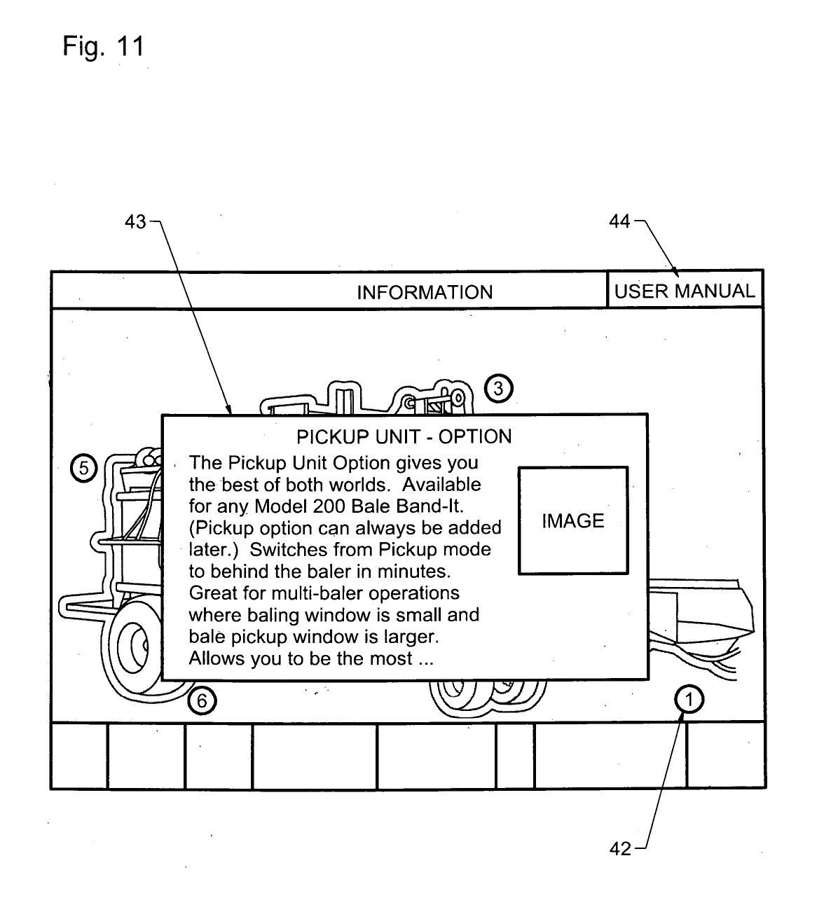

FIG. 11 shows the Information Screen, comprising one or more of the features, GUI's and functions described herein, which enables the operator to learn more about a specific feature, operation or area of the implement, such as the Bale Band-It bundler. The operator touches the on-screen Bale Band-It GUI 42 to begin drilling down into detailed content 43. Resources such as operator's manual 44 sections for each chosen subsystem and component are shown on the screen.

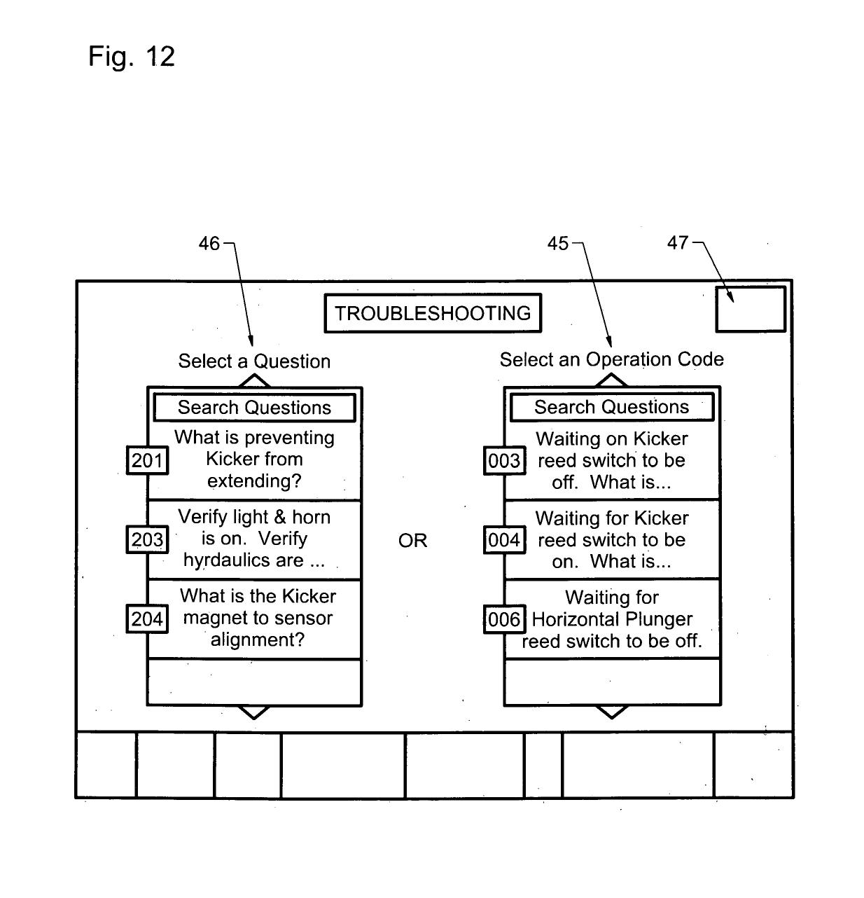

FIG. 12 shows the Troubleshooting Screen embodiment of the subject invention, comprising one or more of the features, GUI's and functions described herein . If a machine problem occurs when operating, for example when forming, packaging, baling or bundling bales in the field, the iBand-It System directs the operator to its in-depth step by step query and troubleshooting system. This system starts with sensors in the applicable machine providing a malfunction alert signal to the microprocessor, conversion of the signal to the appropriate operational code 45, wireless transmission of the operational code 45 to the i-Bandit System interface screen and then visually or audibly prompts operator to select what state or step of operation the Bale Band-It currently is in. In another embodiment, the screen utilizes sensor input from the malfunctioning machine to automatically determine the state the machine is in. In either case, after receiving the input of machine state, the i-Bandit System then queries its resident repair database and provides a graphical picture and the specific repair procedure to repair or replace the component that caused the applicable malfunction. Unlike prior art methods of using paper manuals and the trial and error methods of replacing parts, this method and device is quick and cost-effective for both experienced users and first time operators. Optionally, if the operator wants to self-train or search for answers to a specific question, then operator can search either the operation code questions 46 or any of the numerous questions already in the database.

For more in-depth troubleshooting, operators are in the preferred embodiment just two clicks away from the inside of both Bale Band-It electrical boxes. Inputs & Outputs as well as rocker switch location 47 can all be viewed in real-time from the System.

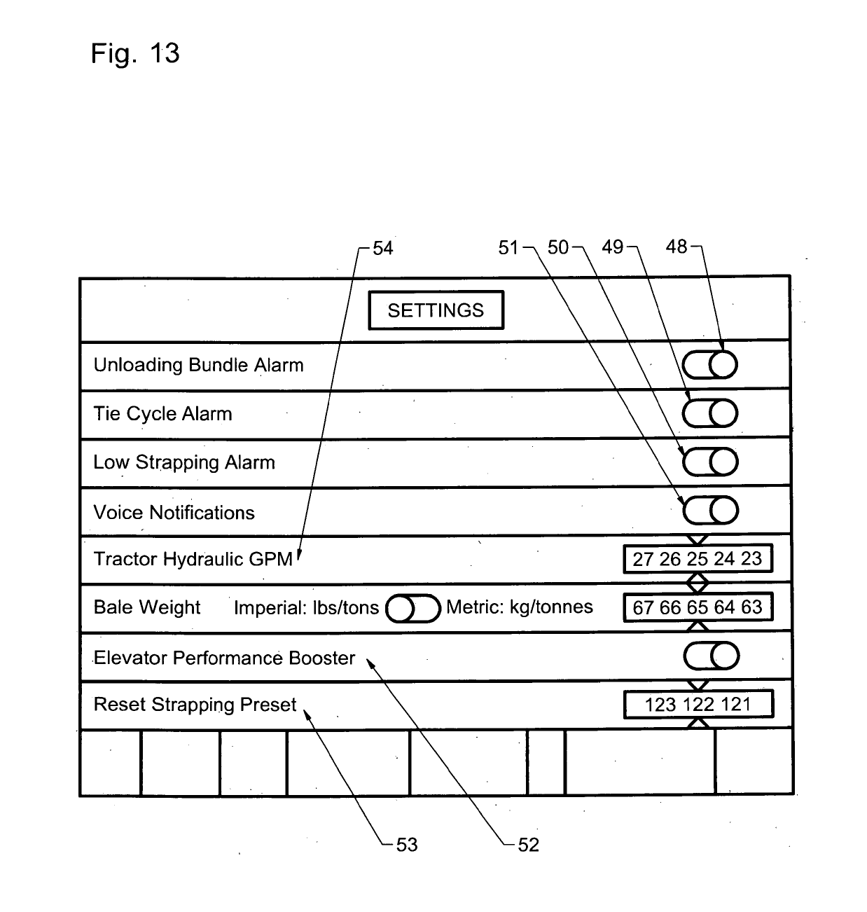

FIG. 13 shows the Settings Screen of the subject invention, said Settings Screen comprising one or more of the features, GUI's and functions described herein. Equipment features, operating parameters, and inputs from both the tractor and baler can all be set or adjusted from the Settings Screen. On the go feature changes are easily performed, including the following: i) Unloading Bundle Alarm 48 manually turned on or off, ii) Tie Cycle Alarm 49 manually turned on or off, iii) Low Strapping alarm 50 manually turned on or off, iv) Voice Notifications 51 when turned on, allowing operator to keep attention on driving route and not require glancing at the screen while moving, manually turned on or off, v) the Elevator Performance Booster 52 manually turned on or off. When turned on, Booster 52 sends signal to bundler microprocessor to operate bale conveyor means in the bundler at increased speed. This reduces the overall cycle time to insert bales and construct, compress, strap and eject a bundle. In the event conditions are particularly dry, baled crop is not well packed, or other crop conditions resulting in bales being clipped by bundler compression means return cycle, effecting productivity, the operator may turn off the performance booster. This sends a signal to the bundler microprocessor to operate the bale conveyor train at a lower speed, enabling each bale to fully clear the compression ram during its return cycle. The Reset Strapping Preset 53 is used by the operator when a replacement reel of strapping is installed on the bundler, and Preset 53 may be manually adjusted if the reel has more or less material than a standard reel, or if the strap count was inadvertently reset. The Tractor Hydraulic Gallons Per Minute (GPM) setting 54 is set by the operator to match that specified or measured by the specific tractor they are using. This GPM setting then automatically is accounted for in the Performance Screen subsystem in setting optimal upper and lower control limits for trend performance analysis and reporting.

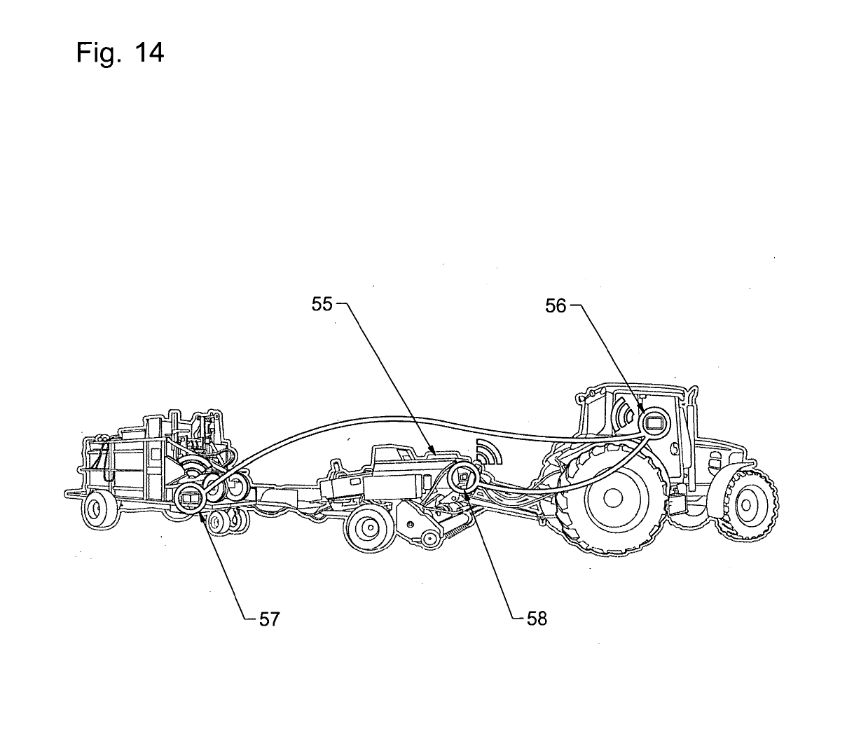

FIG. 14 shows the Wireless Data Link screen format of the subject invention, comprising one or more of the features, GUI's and functions described herein. The Baler Stroke Count Gauge 6 receives its signals wirelessly from baler's Bluetooth or other wireless transmission device 58 (see FIG. 14). The baler's wireless transmission device 58 receives information from stroke sensor means 55 mechanically mounted on the baler. Stroke Sensor means 55 preferably are comprised of an electromechanical reed switch or electronic proximity switch, preferably mounted in a location shielded from or outside of the flowpath of cut crop materials moving through the baler. These switches are mechanically or electronically activated by the motion or stroke of the baler compression arm means, then transmit signals via the Baler's wired or wireless network to the Bale Bandit bundler microprocessor, which then calculates the stroke counts for each bale produced by the baler and sends the data to the iPad interface. The system may alternatively send the stroke count and bale production signal output directly to the iPad interface for calculation and display.

FIG. 14 shows a preferred embodiment describing how the monitor 56 wirelessly connects to both the Bale Band-It's Bluetooth or other wireless data transmission/receiver device 57 and the baler's Bluetooth or other wireless data transmission/receiver device 58. It also indicates another embodiment of the invention, one or more of the above screens, outputs or data signals is uploaded via cellular or other wireless network means to one or more central data busses utilized by support technicians, that would notify them automatically of a pending or actual problem with the baler, the Bale Band-It or both, optionally with the error or subsystem problem code, what operation the machine was in, number of cycles per subsystem since subcomponent maintenance, etc, enabling them to remotely troubleshoot the operator's equipment and provide the operator with instructions and spare parts, or dispatch a trained technician, to perform the necessary corrective actions or maintenance.

In another embodiment of the invention, prerecorded video demonstrations are used providing explanations, procedures, and training. In another embodiment of the invention, using video conferencing to directly connect operator with such technician.

In another embodiment of the invention, integrating data from the System to work in conjunction with other software on other computers. For example, the iBand-it System will download data for use on software used on a personal computer. This personal computer software would allow operators to see and manage their data at different computer locations and with potentially new more developed techniques.

In another embodiment of the invention, the System has the capability so that the operator could find any needed part in the on-screen BOM, gives the part number needed, and then able to place parts order wirelessly all from the System. In another embodiment of the invention, when manufacturer provides any software update for their serial number machine, the operator would be notified via the System, and the i-Bandit System system would receive the update via wireless data link, then transmit the update directly into the memory storage means in the implement machine onboard computer.

In another embodiment of the invention, allowing System to connect to additional Bluetooth or wireless data communication devices, in order to gather additional data inputs such as videos from cameras mounted on equipment. Videos could be viewed live while working though the field, either from the cab of the tractor or on a remote display. In another embodiment of the invention, a photosensor, weigh sensor, transfer wheel totalizer or other similar device would monitor baler twine usage, transmit the signals through a microprocessor and/or the wireless data means to the interface, whereby the interface would compare said usage to a preset starting twine value input by the operator stored in the interface database, to then generate an output report of the twine usage and/or remaining baler twine count. Another embodiment includes the option

In another embodiment of the invention, System to be used to monitor, report and store data from moisture detector means on the baler. In another embodiment of the invention, the subject invention can be used as a preservative applicator controller during hay baling operations. In a similar method and sensor arrangement contained in the subject invention, viewing, setting, and controlling of all key parameters such as but not limited to: applied rate of preservative, fan or motor or pump applicators, and status of machinery can be monitored, processed and displayed on the interface or downloaded over a wireless network.

In another embodiment of the invention, app to be used to control tractor ground speed based off specified stroke count range of baler. This would be accomplished through the app controlling the fuel federate and/or transmission of the tractor, automatically controlling ground speed to get optimum bales per unit time baler performance. In another preferred embodiment, by utilizing the stroke count per bale per linear feet traveled by the system, the system can also automatically provide the operator a color or graphically coded map for each field, or for each section of each field, indicating how many bales per unit area and by utilizing average weight per bale how many pounds of product were yielded per unit area of land area harvested. The unit of measurement may be customized to be per square yard or per acre, or per metric measures. The farmer or operator may then subsequently utilize this yield per unit area map to adjust fertilizing rates, and/or supplemental water application, to boost yields on the lower-producing fields, or sections of fields, to optimize overall yield and minimize excess application of fertilizer and/or water leading to runoff and wastage of water or fertilizer.

In another preferred embodiment the locations of alternating good, marginal and poor yielding areas are downloaded for a programmable fertilizer or water application device coupled with either a standard manual or a programmable tractor or other transport device, to automatically adjust the application of the optimal amount of fertilizer and/or water to specific areas of each field, to optimize fertilizer and or water use and better normalize the yield in each field.

In another embodiment of the invention, the i-Bandit-app and System, with obvious modifications to those skilled in the art, can to be used to monitor, troubleshoot and/or control baler operation, functions, and maintenance parameters. Alternatively, the same claimed method and similar equipment could collect data and control, monitor and report on other equipment, for example other farm equipment such as cotton balers and input applicators, wirelessly.

In another preferred embodiment, the app system includes a speech recognition module, enabling all outputs, alerts and operator inputs at the human-machine-interface terminal to all be audibly-based.

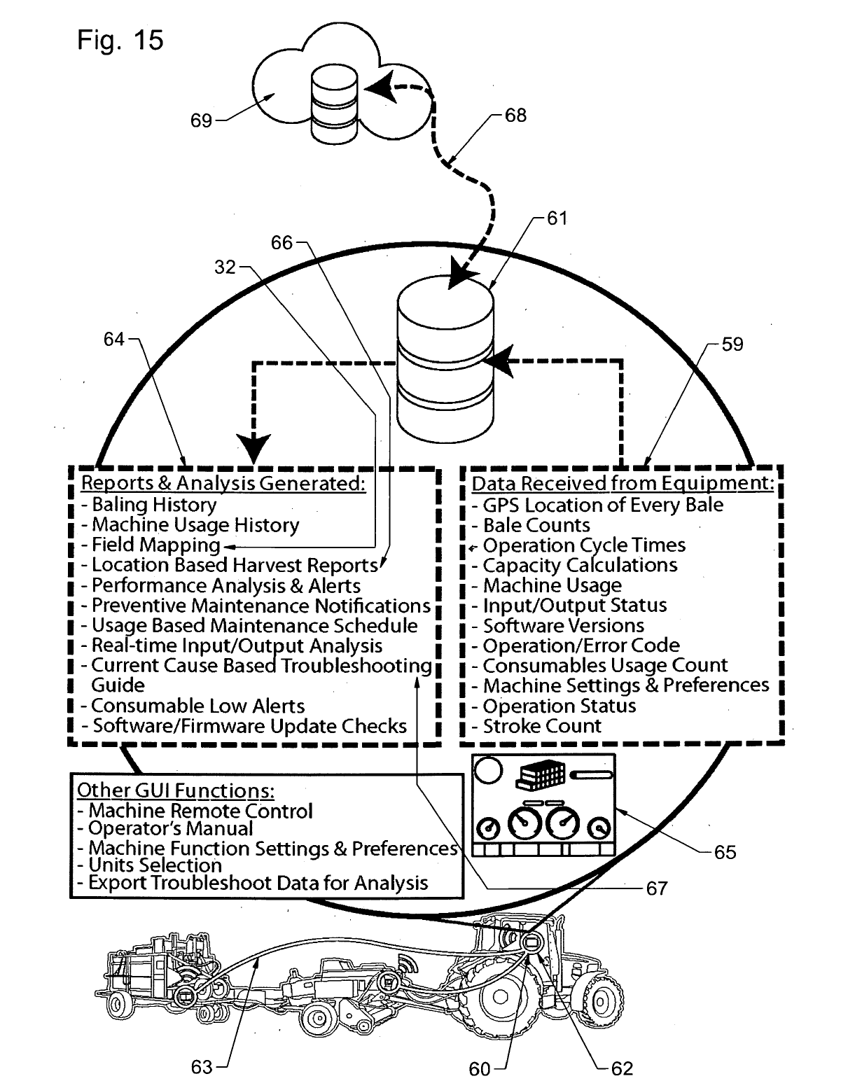

Referring to FIG. 15, the preferred embodiment is one or more of a series of inputs 59 from the i) implement equipment, such as a baler stroke counter and/or one or more sensors on the bundler, ii) the operator of the equipment or iii) both the operator and the equipment being operated, sending data to the microprocessor 60 and database 61 resident preferably in a mobile flat screen monitor human-machine-interface 62 such as an iPad or other similar wireless device, such data transmitted via a wireless frequency spectrum means 63 such as via Bluetooth or cellular, such interface generating one or more outputs 64 including one or more various graphical user interfaces 65, signal means to one or more implement components, one or more maps 32, performance reports 66 and/or operation, maintenance or repair recommendations 67, all disclosed hereinabove, preferably in real time or provided shortly after or during building or completion of each complete or partial bale or bundle of hay bales or other crop, visibly displayed or audibly transmitted by the interface 62 and in another embodiment also via wireless data link (68) to one or more remote computer database registers 69. Such optional cellular means could include a data link that utilizes a personal area network built using any cellular wireless technology from the list comprising frequency division multiple access (FDMA), code division multiple access (CDMA), polarization division multiple access (PDMA) and time division multiple access (TDMA).

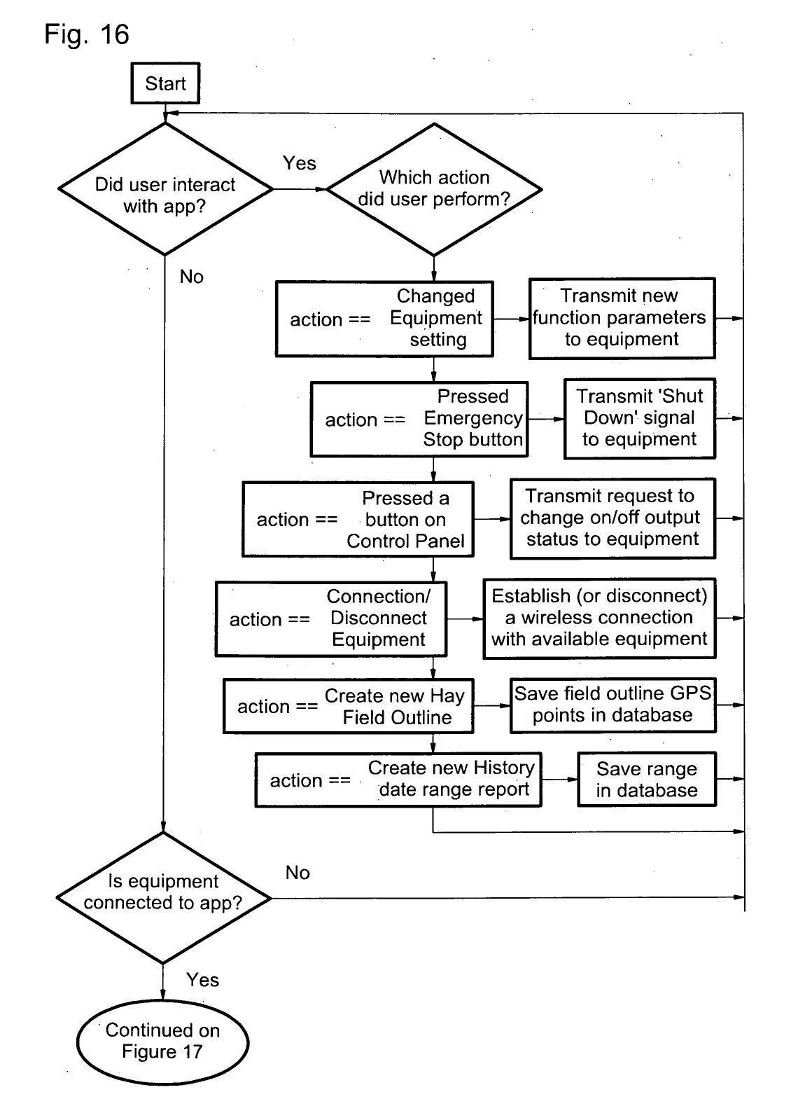

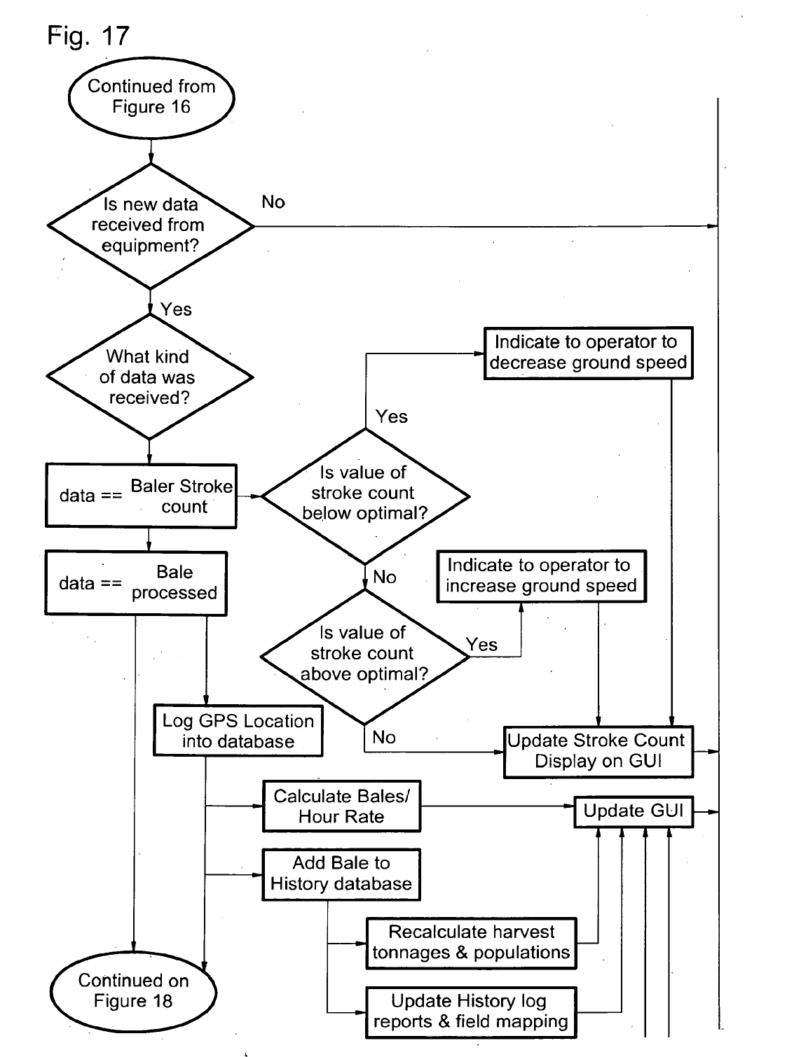

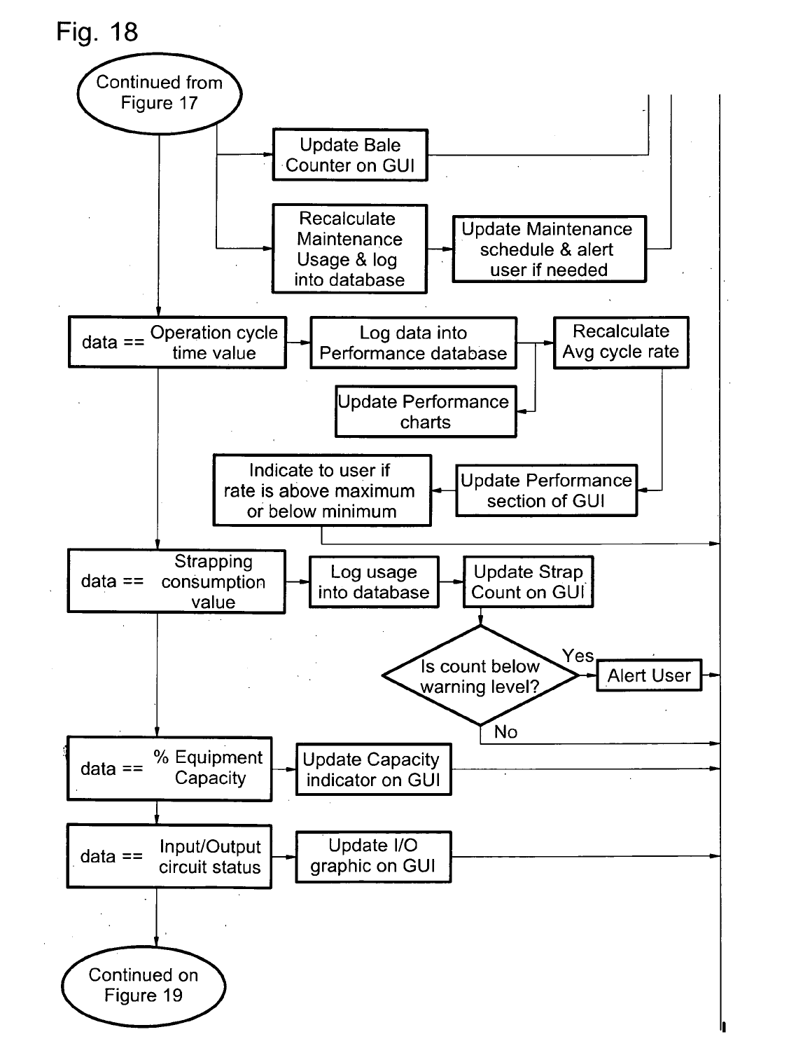

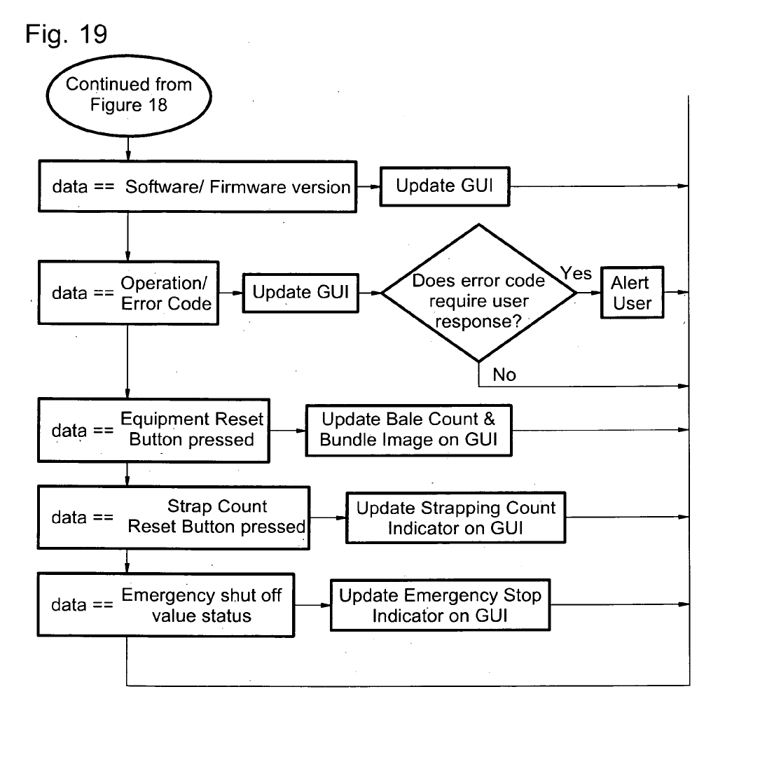

Referring to FIGS. 16 and 17, these depict the method to input and process various parameters used in the i-Bandit app system to generate the desired outputs of the subject invention.

The above descriptions are general in nature and specific obvious variations in materials, screen formats, methods, applications, equipment and operational sequences may be included without departing from the scope and intent of this disclosed invention.

### CITATION LIST

### Patent Literature:

### U.S. Patent Application Publications:

No. 20100065155 dated Mar. 18, 2010
No. 20140012732 by Lindores, dated Jan. 9, 2014
No. 20010042362 dated Nov. 22, 2001, Scarlett et al
No. 20120136507
No. 20130116896 dated May 9, 2013, Blank

### Non Patent Literature:

University of Nebraska, Article http://cropwatch.unl.edu/web/ssm/mapping,

What is claimed is:

1. A system and method for monitoring, controlling, optimizing and troubleshooting mobile equipment comprising:
a. A portable human-machine-interface means including:
i. a data storage means,
ii. wireless data transmission and receiving means,
iii. a microprocessor means, an input means and
iv. an output display means,
b. A motorized towing vehicle,
c. One or more mechanical implements coupled to said towing vehicle.
d. One or more sensors on one or more of such implements,
e. A microprocessor on one or more of such implements,
f. A wireless data link means communicating between such interface, sensors microprocessor (s),
g. A software program resident within such interface, integrating such processed sensor outputs into said interface,
h. One or more outputs from said interface visibly, electrically or audibly supplied to the operator of said towing vehicle, one of such outputs comprising:
(i) equipment repair procedures or
(ii) equipment actuator stroke count.

2. The system and method of claim 1 where said interface includes two or more of the following:
a. a flat panel touch display,
b. microphone input or
c. speaker output means.

3. The system and method of claim 1 where said interface is comprised of:
a. an iPad,
b. an Android or
c. other similar wireless data communication and processing touch screen terminal.

4. The system and method of claim 1 where said interface includes a keyboard input means.

5. The system and method of claim 1 where said interface includes a self-contained power supply.

6. The system and method of claim 1 further including an electric or hydraulic power supply means located on said motorized towing unit or one or more implements.

7. The system and method of claim 1 where said motorized towing vehicle is a tractor.

8. The system and method of claim 1 where said motorized towing unit is any from a list of machines comprising:
a. a truck,
b. payloader,
c. forklift,
d. backhoe or
e. grader.

9. The system and method of claim 1 where said implement is any component or plurality of components from a list comprising:
a. a tractor,
b. mower,
c. spader,
d. baler,
e. seed applicator,
f. fertilizer applicator,
g. water applicator,
h. herbicide applicator,
i. bale handler,
j. accumulator or
k. bale bundler machine.

10. The system and method of claim 1 where said sensor is an electromechanical or electronic means mounted on a mechanically actuating portion of the plunger of a baler thereby transmitting a signal impulse upon each stroke of said actuating portion.

11. The system and method of claim 1 where said sensors comprise a plurality of sensors measuring
a. implement outputs or
b. instrument parameters including two or more of the group comprising:
i. operating step times,
ii. movement,
iii. temperature,
iv. consumables remaining,
v. pressure,
vi. mechanical means location,
vii. actuator status,
viii. valve status,
ix. fluid levels,
x. flowrate,
xi. product location,
xii. product shape and
xiii. product amounts.

12. The system and method of claim 1 where said data link utilizes a personal area network built using the Bluetooth wireless technology standard.

13. The system and method of claim 1 where said data link utilizes a personal area network built using any cellular wireless technology from the list comprising:
a. frequency division multiple access (FDMA),
b. code division multiple access (CDMA),
c. polarization division multiple access (PDMA) and
d. time division multiple access (TDMA).

14. The system and method of claim 1 where said interface transmits and receives data wirelessly to a remote computer or server separate and apart from the mobile implement or towing vehicle.

15. The system and method of claim 1 where said software program is written in Objective C.

16. The system and method of claim 1 where said software program in said interface:
a. converts a plurality of signal inputs received from said data link, and
b. processes said inputs to produce one or more outputs.

17. The system and method of claim 1 where said software program performs said method for generating an implement recommendation, alarm or report, said method comprising:
a. receiving at a radio frequency receiver of an implement monitoring, reporting or recommendation computer system a plurality of data sets from a plurality of sensors and data sources resident on said implement, wherein each of said plurality of data sets describes a factor or system condition affecting or reporting the
i. operation,
ii. efficiency,
iii. performance,
iv. safety or
v. maintenance of an implement,
b. comparing a preset or programmable database of optimal or preferred range of values for one or more data sets in said computer system to one or more data sets; and
c. generating an audible or visible output to said interface using an output generator of said computer system, said output comprising at least one of the following:
i. recommendation or signal means to change the linear travel rate of such vehicle implement,
ii. plunger stroke count per bale,
ii. yield maps,
iv. reports of the output of products per unit time or per unit area travelled,
v. the status of implement components' performance, status or condition,
vi. recommendation to perform a specific inspection, repair or replacement procedure on a component of the implement,
vii. detailed instructions or pictures for the performance of said recommended repair or maintenance, and indication of specific components or assemblies needing repair,
viii. maintenance or replacement in the near future,
ix. a pictorial operations and repair details for one or more implement components or assemblies,
x. one or more signals to either stop or actuate designated implement components or subassemblies in a preset or specified speed and direction, or
xi. a bill of material of implement spare parts with interactive GUI purchase order placement means.

18. The software program method of claim 17 wherein said outputs include a decision-tree query process resulting in a repair method recommendation.

19. The software program method of claim 17 wherein said outputs include real-time statistical quality or process control trend analysis or control charts of the monitored components or implements.

20. The software program method of claim 17 wherein said outputs include at least one of the following:
a. recommendation or signal means to increase, maintain or decrease the linear travel rate of such vehicle or implement,
b. implement stroke count,
c. the output of products per unit time or per unit area of crop gathered,
d. the status of implement components' performance, status or condition of components,
e. recommendation to perform any specific inspection, repair or replacement procedure on a component of the implement based on such reported component status or condition,
f. repair procedures, or
g. an indication of components needing maintenance, repair or replacement immediately or in the near future.

21. The software program method of claim 17 wherein said outputs further include a plurality of screen formats containing one or more GUI means and on each screen resulting in one or more outputs or functions, said screen formats comprising any two or more from the list comprising
a. a Main Screen,
b. Troubleshooting Screen,
c. Controls Screen,
d. History Screen,
e. Performance Screen,
f. Info Screen or
g. Settings Screen.

22. A system and method for:
a. monitoring,
b. controlling,
c. optimizing or
d. troubleshooting a baler or bale bundler or bale accumulator machine comprising:
i. A portable flat touch screen human-machine-interface means including
ii. a data storage means,
iii. wireless data transmission and receiving means,
iv. a microprocessor means,
v. an input means and
vi. an output display means,
e. A motorized tractor means,
f. One or more balers or bundlers connected mechanically to said tractor means.
g. A plurality of sensors on the bundler, baler, accumulator or combination thereof,
h. A microprocessor on one or more of such baler, accumulator or bundler,
i. A wireless data link means communicating between such interface, sensors or microprocessor (s),
j. A software program resident within such interface, integrating such processed sensor outputs into said interface, including a method of generating baler, accumulator or bundler recommendation or report, said method comprising:
i. receiving at a wireless receiver of such monitoring, reporting or recommendation system a plurality of data sets from sensors
1. on the baler or
2. a plurality of sensors or data sources resident on said bundler or accumulator, wherein said plurality of data sets describes a factor or system condition or output
a. controlling,
b. affecting or
c. reporting the operation, efficiency, performance, safety or maintenance of the bundler, accumulator or the baler,
ii. comparing a preset or programmable database of optimal or preferred values or range of values for one or more data sets in said computer system to applicable received data sets; and
iii. generating an audible or visible output to said interface using an output generator of said computer system, said output comprising at least two of the following:
1. recommendation or signal means to increase or decrease the linear travel rate of such implement,
2. reports to the output of products per unit time or per unit area travelled,
3. the locations and quantity of baled or bundled crop product,
4. the status of implement components' performance, status or condition,
5. recommendation to perform a specific inspection, repair or replacement procedure on a component of the implement,
6. detailed stepwise pictorial procedures to perform such recommended repair, or
7. an indication of components needing repair or replacement immediately or in the near future.
k. One or more outputs from said interface visibly, electrically or audibly supplied to the operator of said tractor.

23. The system and method of claim 22 further including:
a. an electric or
b. hydraulic power supply means located on said tractor, baler, bundler or accumulator.

24. The system and method of claim 22 wherein such preferable or optimal values and upper and lower control limits of such values automatically are adjusted by the software when operator inputs tractor-specific hydraulic
a. capacity or
b. flowrate values into the interface.

25. The system and method of claim 22 further including a plunger stroke sensor means on the baler.

26. The system and method of claim 22 wherein such interface includes means for operator to reduce or increase performance speed of the bundler to account for:
a. crop condition or
b. baling or bundling conditions to reduce malfunctions.

27. The system and method of claim 22 wherein such operator of said tractor is a robotic system comprising
a. a data receiver means,
b. a microprocessor and
c. one or more electromechanical or electro pneumatic output means to adjust the tractor fuel flowrate and/or transmission gear ratio.

28. The system and method of claim 22 wherein such interface includes:
a. a database of spare parts available for one or more components in use, and the output of said interface includes an on-screen bill of material (BOM) of spare parts available,
b. a GUI input means whereby the operator of said interface can locate needed parts and place parts orders wirelessly to a remote spare parts provider.

29. The system and method of claim 22 which also includes a speech recognition module, enabling outputs, alerts or operator inputs at the human-machine-interface terminal to be audibly-based.

30. The system and method of claim 22 wherein said system and method:
a. computes the baler stroke count per bale per linear feet traveled by the system, and
b. Outputs to the interface a color or graphically coded map for each field, or for each section of each field, indicating how many bales per unit area were produced and
c. by utilizing average weight per bale displays how many pounds of product were yielded per unit area of land area harvested.

31. The system and method of claim 22 wherein such output includes a graphical yield map indicating:
a. unit weight of crop product baled per unit area,
b. locations and approximate weights of bales or bundles of bales produced or ejected from the baler, accumulator or bundler or both weight per area and locations of product.

32. The system and method of claim 22, wherein such output includes the coordinates of the locations of good, marginal or poor yielding areas as compared to a benchmark, wherein such coordinates are stored and subsequently downloaded for a programmable fertilizer or water application device coupled with:
a. a manual or a programmable tractor or
b. other transport device, to adjust the application of the optimal amount of fertilizer or water to specific areas of a field.

33. The system and method of claim 22 wherein such stroke sensor means is comprised of
a. an electromechanical reed switch or
b. electronic proximity switch, mounted in a location shielded from or outside of the flowpath of cut crop materials moving through the baler.

34. The system and method of claim 22 wherein such bundler or baler shall mean one or more mechanical implements from a group comprising:
a. a crop cutter means,
b. spading means,
c. seed planter means,
d. fertilizer applicator means,
e. herbicide applicator means or
f. cotton baler means.

35. The system and method of claim 22 wherein such sensor includes a commercially available moisture detector means to monitor, report and store data from moisture detector means on the baler.

36. The system and method of claim 22 further including:
a. a chemical preservative applicator means and
b. flow sensing and control valve means at the baler whereby the interface and software provides preservative applicator control, process, monitor or display inputs and outputs on the interface or transmits the data to one or more remote servers over a wireless network during baling operations.

37. The system and method of claim 22, further including an interface system providing viewing, setting, or controlling of parameters including one or more of the following:
a. applied feedrate of preservative,
b. amount of preservative available,
c. speed or amperage of fan or motor or pump applicators,
d. repair or replacement recommendations,
e. spray pattern,
f. fluid pressures,
g. temperatures and
h. status of machinery

38. The system and method of claim 22 further including:
a. one or more video camera means and
b. one or more additional wireless receiver-transmission means sending such video camera outputs to:
i. the operator interface screen or
ii. a remote server or monitor.

39. The system and method of claim 22 whereby one or more sensors on said baler measures and transmits data to the interface which displays outputs of remaining baler twine count or usage rate.
